(19) United States
(12) Patent Application Publication
(10) Pub. No.: US 2015/0279507 A1
(43) Pub. Date: Oct. 1, 2015

(54) ENAMELLED WIRE

(71) Applicant: SCHWERING & HASSE ELEKTRODRAHT GMBH, Lügde (DE)

(72) Inventors: Roxana Haase, Bad Pyrmont (DE); Johann Reicher, Bad Munster (DE)

(73) Assignee: SCHWERING & HASSE ELEKTRODRAHT GMBH, Lügde (DE)

(21) Appl. No.: 14/646,401

(22) PCT Filed: Oct. 24, 2013
(86) PCT No.: PCT/EP2013/072291

§ 371 Date: May 21, 2015

(30) Foreign Application Priority Data
Nov. 23, 2012 (DE) 10 2012 111 372.6

(51) Int. Cl. H01B 3/00; H01B 13/00; H01B 1/02

(52) U.S. Cl. CPC H01B 3/002; H01B 1/02; H01B 13/0016

(57) ABSTRACT

Enamelled wire, particularly enamelled copper wire or enamelled aluminium wire, wherein one surface of a winding wire forming a core of the enamelled wire is completely or substantially completely coated with an electrically insulating varnish consisting of at least one varnish resin. The electrically insulating varnish contains at least one nano filler, wherein the nano filler is formed of a plurality of platelets. A platelet jacket formed by the nano filler completely or substantially completely encloses the winding wire.

The invention relates to an enameled wire, particularly enameled copper wire or enameled aluminum wire.

Enameled copper wires and/or enameled aluminum wires are generally known from the practice. These enameled wires are used in electric machines to generate electric fields. For this purpose a plurality of windings of the enameled wire is arranged in a groove, for example. The effectiveness of the machines known from prior art depends on the utilization of the groove area available and the ratio of the active area (slot filling factor). In order to achieve the electric stability required, the enameled wires are coated with an insulating varnish. In the wires insulated by enamel known from prior art the insulating varnish must show a predetermined minimum thickness in order to yield the necessary electric features, such as dielectric strength. The predetermined minimum thickness of the layer is therefore one of the limiting factors to yield higher slot filling factors.

The invention is therefore based on the technical problem to provide an enameled wire of the type mentioned at the outset which is characterized in an advantageously thin insulating varnish, by which a groove area can be utilized optimally and by which the fill factors known from prior art can be improved. Furthermore, the invention is based on the technical problem to provide a method for the production of an enameled wire, which is characterized in a simple implementation and high environmental safety as well as energy efficiency.

In order to attain the technical problem the invention teaches an enameled wire, particularly enameled copper wire or enameled aluminum wire, with a surface of a winding wire, forming the core of the enameled wire, being completely or substantially completely coated with an electrically insulating varnish made from a varnish resin, with the electrically insulating varnish comprising at least one nano filler, with the nano filler being formed by a plurality of platelets, with a platelet coat formed by said nano filler preferably completely and/or substantially completely covering the winding wire.

The enameled wire can be used in coil forms, for example in electric machines for the generation of electric fields. Advantageously the winding wire is made substantially and/or completely from copper or aluminum. In general, the use of arbitrary, electrically conductive materials, preferably metals, is possible for the winding wire. The varnish resin is preferably a matrix, in which the nano filler and/or the platelets are arranged. Particularly preferred, the platelets and/or the nano filler are exclusively arranged in the polymer matrix. According to a preferred embodiment the platelets show a uniform and/or substantially uniform alignment. It is recommended that surfaces of the platelets of a platelet layer, oriented parallel and/or substantially parallel in reference to the winding wire, form a preferably cylindrical jacket surface.

Beneficially the platelets are arranged preferably without overlapping and/or substantially without overlapping along a longitudinal axis of the winding wire inside the platelet coat and/or the platelets are arranged preferably without overlapping and/or substantially without overlapping inside the platelet coat surrounding the winding wire. It is recommended that adjacent platelets are arranged at a distance from each other inside a platelet coat. According to one embodiment adjacent platelets directly abut each other, with it being possible that sectionally a clear space is formed between adjacent platelets, filled with the varnish resin. It is recommended that at least two platelet jackets and preferably at least three platelet coats cover the winding wire. Particularly preferred, at least two platelet coats are beneficially arranged off-set in reference to each other around the winding wire such that platelets of one external platelet coat are positioned in the radial direction above the platelet clearances, which platelet clearances are formed between adjacent platelets of an internal platelet coat. According to one embodiment, at least two platelet coats and/or the internal platelet coat and the external platelet coat preferably form in their projection upon the winding wire a continuous and/or substantially continuous jacket about the winding wire. The scope of the invention includes that the platelets are arranged in a polymer matrix arranged by the varnish resin. It is possible that at least a portion of the platelets directly rests on the winding wire. According to one embodiment the platelets are for the most part and particularly preferred entirely embedded in the polymer matrix such that varnish resin is arranged between the platelets and the winding wire.

Preferably an aspect ratio of the nano filler and/or the platelets is greater than 100. Here, within the scope of the invention, aspect ratio relates particularly to the ratio of the lateral extension of the platelets in reference to the thickness of the platelets. The lateral extension is preferably the longest possible chord through a cross-sectional area of a platelet. In a platelet with a circular cross-sectional area the lateral extension represents for example the diameter of the circular cross-sectional area of the platelet. The thickness of a platelet is oriented perpendicular to the cross-sectional area, for example. Preferably, the aspect ratio is greater than 1,000. According to one embodiment the aspect ratio ranges from 500 to 1,000, preferably from 100 to 5,000, and particularly preferred from 100 to 10,000.

Advantageously the platelets show a thickness of maximally 20 nm. It is recommended for the platelets to show a thickness of a few nanometers, for example ranging from 1 to 15 nm, preferably from 1 to 10 nm, and particularly preferred measuring up to 5 nm.

Beneficially the platelets show a lateral extension of at least 100 nm. It is possible for the platelets to show a lateral extension of at least 300 nm and preferably at least 500 nm. According to a preferred embodiment the lateral diameter of the platelets ranges approximately from 100 to 100,000 nm, and preferably from 100 to 50,000 nm.

It is recommended for the nano filler to represent a phyllosilicate. According to one embodiment a mixture of various phyllosilicates is used as the nano filler. Preferably the platelets consist of phyllosilicates and/or substantially from phyllosilicates. It is possible that platelets of various phyllosilicates are included in the electrically insulating varnish. Particularly preferred, the platelets are obtained by way of exfoliating. Beneficially the phyllosilicate represents a component selected from the group “talcum, hectorite, montmorillonite, bentonite.” It is within the scope of the invention that the nano filler substantially comprises any arbitrary phyllosilicate.

It is recommended that the phyllosilicate is organically modified, with an organically modified phyllosilicate comprising at least one preferably cationic surfactant. The organically modified phyllosilicate can be obtained by ion exchange techniques, for example, with cations embedded in the phyllosilicate being exchanged by the preferably cationic surfactant. Ammonia, sulfonium, or phosphonium salts, for example, may be used as cationic surfactants. Preferred are ammonium salts, particularly quaternary ammonium salts of the following general formula:

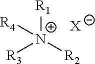

with R₁ to R₄ representing organic moieties, selected from the group “alkyl, acyl, aryl, aryl alkyl, ester, or fatty ester groups.” The moieties R₁, R₂, R₃ and R₄ may be identical or different from each other. The anion X⁻ may represent an inorganic or organic anion, for example Cl⁻, methyl-sulfonate CH₃OSO₃⁻. An example or a surfactant is shown in the following formula:

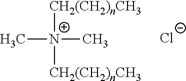

Beneficially, n represents a natural number from 0 to 20.

According to a preferred embodiment the electrically insulating varnish comprises up to 10% by volume nano filler. The statements in percent by volume relate to the volume of the electrically insulating varnish with the nano filler contained therein. Beneficially the electrically insulating varnish comprises 0.5 to 8% by volume nano filler, preferably from 1 to 7% by volume, and particularly preferred from 1 to 5% by volume.

Preferably the ratio of the diameter of the winding wire to the thickness of the electrically insulating varnish squared is greater or equivalent to 1.0 μm⁻¹. Beneficially the ratio of the diameter of the winding wire to the thickness of the electrically insulating varnish squared is greater or equivalent to 2.5 μm⁻¹, preferably greater or equivalent to 3.5 μm⁻¹, and particularly preferred greater or equivalent to 4.2 μm⁻¹. According to one embodiment the ratio of the thickness of the winding wire to the thickness of the electrically insulating varnish squared amounts to at least 5.1 μm⁻¹, preferably at least 6.3 μm⁻¹, and according to one embodiment at least 8.1 μm⁻¹. Preferably the ratio of the diameter of the winding wire to the thickness of the electrically insulating varnish squared amounts to at least 4.2 μm⁻¹, if the diameter of the winding wire preferably ranges from 100 μm to 1000 μm. According to one embodiment the ratio of the thickness of the winding wire to the thickness of the electrically insulating varnish squared amounts to more than 8.1 μm⁻¹, if the winding wire shows a thickness of preferably more than 1000 μm. Beneficially the winding wire shows a diameter of at least 100 μm, preferably at least 150 μm, and particularly preferred at least 200 μm. The thickness of the electrically insulating varnish amounts to at least 3.5 μm according to a preferred embodiment.

According to one embodiment the electrically insulating varnish is formed by at least two, preferably identical and/or substantially identical layers of electrically insulating varnish. It is possible that the electrically insulating varnish is formed by more than two and/or a plurality of electrically insulating varnishes. One electrically insulating varnish includes at least the varnish resin and the nano filler. It is within the scope of the invention that at least one additional layer, preferably different from the electrically insulating varnish, is arranged on said electrically insulating varnish.

Beneficially, the varnish resin comprises at least one component selected from the group “polyester, polyester-imide, polyamide-imide, polyimide, polyurethane, polyester-amide-imide, polyamide, polyvinyl-formal.” The polyester is, for example, a THEIC-polyester. The polyester-imide may represent a THEIC-polyester-imide. THEIC represents, within the scope of the invention, primarily tris-hydroxy ethyl isocyanurate. According to one embodiment the polyamide is an aliphatic and/or aromatic polyamide. The polyamide may represent a polyamide, which shows aliphatic structural units and/or aromatic structural units. It is within the scope of the invention that the varnish resin shows modification units. For example, the polyester may comprise THEIC-modification units or non-polar alkyl chains (end group modification). The polyester-imide may be THEIC-modified. The polyurethane may be e.g. isocyanurate, silane, or siloxane-modified. Instead of polyamide or polyamide-imide, for example polytetra-fluoroethylene (PTFE) or siloxane, preferably polysiloxane, particularly polydimethyl-siloxane may be used as modification units. It is possible that at least one additional functional layer is arranged on an exterior side and/or the external surface of the electrically insulating varnish. By the functional layer arranged on the external surface for example the gliding behavior of the enameled wire can be optimized. According to one embodiment, a gliding layer is arranged on the external surface of the electrically insulating varnish. The friction coefficient of the gliding layer is preferably lower than a friction coefficient of the electrically insulating varnish. This way it is ensured that a better spatial utilization occurs during the production of the winding body comprising the enameled wire.

Furthermore, in order to solve the technical problem the invention teaches a method for the production of an enameled wire, with a nano filler, comprising a plurality of platelets, being dispersed in a varnish resin and/or precursor of a varnish resin, with a winding wire being covered with a coating comprising varnish resin with the nano filler dispersed therein and/or a precursor of the varnish resin with the nano filler dispersed therein, with the winding wire covered with the coating being guided through a coating nozzle such that the platelets of the nano filler form a platelet coat surrounding the winding wire, with the coating on the winding wire preferably being cured by heating to form an electrically insulating varnish. Beneficially, a coating is formed on the winding wire in the electrically insulating varnish, which includes a layer made from a plurality of platelet coats.

Precursors of varnish resins are for example polymerized compounds, from which varnish resin can be synthesized. Beneficially the winding wire is cleaned prior to the varnish resin being applied, comprising the nano filler and/or the precursor of varnish resins comprising nano filler. It is within the scope of the invention that the winding wire is guided through a heat treatment installation for cleaning Here, within the scope of the invention a heat treatment installation represents particularly a pipe with water vapor flowing through it. Preferably the layer is formed from the electrically insulating varnish on the winding wire, for example by applying wet varnish onto the winding wire, preferably in a varnish bath. The varnish bath may be formed by the varnish resin, with particularly preferred nano filler homogenously dispersed in the varnish resin as well as at least one solvent. According to one embodiment the varnish resin comprising nano filler and/or the precursor of the varnish resin comprising nano filler is preferably applied on the winding wire without any solvents. Advantageously, excess wet varnish accepted by the winding wire or varnish resin comprising nano filler and/or precursors of the varnish resin comprising nano filler are stripped off the winding wire using coating nozzles. According to one embodiment, by the application process of the wet varnish or the varnish resin comprising the nano filler and/or the precursor of the varnish resin comprising the nano filler, by the coating nozzle and the preferably laminar flows and the shearing forces developing here an alignment of the nano filler and/or the platelets of the nano filler along the winding wire is promoted. Beneficially the platelets of the nano filler and/or the nano filler are aligned by the guidance of the winding wire coated with wet varnish or the varnish resin comprising platelets and/or the precursor of varnish resin comprising the platelets such that the nano filler and/or the platelets of the nano filler form or develop a platelet coat, which platelet coat surrounds the winding wire. Particularly preferred, the platelet coat formed by the nano filler completely and/or substantially completely surrounds the winding wire. When conveying the winding wire through the coating nozzle, particularly by the flow conditions, it is achieved that the platelets of the nano filler are arranged around the winding wire in the platelet coat without overlapping. Preferably the platelets are aligned for the purpose of forming a jacket made from a plurality of platelet coats, in which jacket the platelets are preferably arranged off-set in reference to each other and/or in a brick-layered structure.

According to one embodiment, the winding wire coated with the wet varnish or the varnish resin comprising the nano filler and/or the precursor of the varnish resin is heated, with preferably the solvent contained in the wet varnish being removed and/or the varnish resin and/or the precursor of the varnish resin being polymerized. Beneficially the varnish resin is yielded by a heat-induced reaction of the precursor of the varnish resin, for example. It is possible that the electrically insulating varnish arranged on the winding wire is formed from a plurality and/or multitude of layers comprising the electrically insulating varnish and/or layers of electrically insulating varnish. In order to form another layer of the insulating varnish on the winding wire, particularly preferred another coating is arranged on the winding wire and/or on an electrically insulating varnish located on the winding wire.

The invention is based on the acknowledgment that an enameled wire according to the invention is characterized in an advantageously low thickness of the electrically insulating varnish applied on the winding wire. This way, with the enameled wire according to the invention considerably improved slot filling factors can be achieved in reference to prior art during the production of coil forms comprising the enameled wire according to the invention. Here, the reduction of the layer thickness of the electrically insulating varnish is essential, which in the enameled wire according to the invention only amounts to from 20 to 80% of the layer thicknesses of electrically insulating varnishes known from prior art. By the density of the windings of the wire that can be achieved by the winding wire according to the invention, the energy efficiency of devices for generating electric fields can be advantageously improved. Due to the small amount of material used here, the method according to the invention is characterized in an environmentally friendly, low emissions-generating, low solvent-consuming process during the production of enameled wires. Due to the fact that for the formation of the enameled wire according to the invention only a low number of various electrically insulating varnishes is required, the method according to the invention is characterized in low energy consumption and thus the enameled wire according to the invention, in a long life.

In the following, the invention is explained based on the drawing illustrating only an exemplary embodiment. It shows schematically:

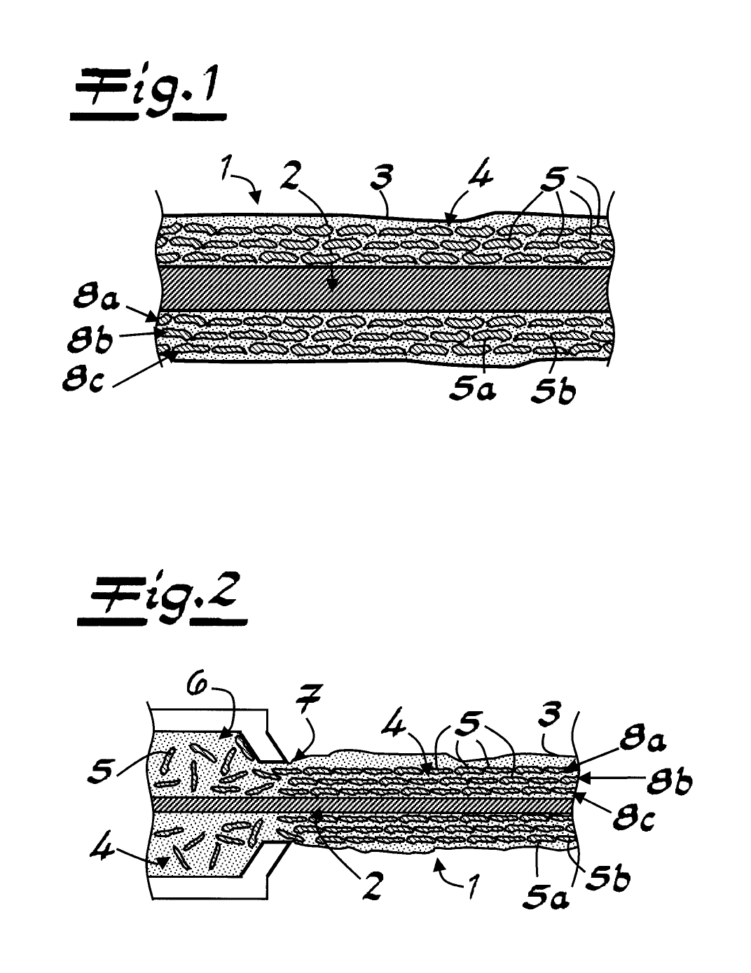

FIG. 1 a cross-section through an enameled wire according to the invention, and

FIG. 2 a simplified, schematic illustration of a device to produce an enameled wire according to the invention.

FIG. 1 shows an enameled wire 1, which comprises a winding wire 2, which winding wire 2 is made from copper in the exemplary embodiment. Preferably and according to the exemplary embodiment the winding wire shows a diameter of 200 μm. The winding wire 2 forms a core of the winding wire 1. According to the exemplary embodiment, the winding wire 2 is completely coated with an electrically insulating varnish 3, which electrically insulating varnish comprises a matrix made from a varnish resin 4 and a nano filler in the form of a plurality of platelets 5. According to the exemplary embodiment and FIG. 1, the platelets 5 form a jacket, which jacket is composed from three platelet coats 8a, 8b, 8c, and completely surround the winding wire 2. FIG. 1 shows that the platelets 5 of the nano filler are embedded in a matrix formed by the varnish resin 4. Furthermore, it is discernible in FIG. 1 that the platelets are arranged in the platelet coats 8a, 8b, 8c without overlapping and around the core of the enameled wire 1 and/or the winding wire 2. The platelets 5 in the platelet coats 8a, 8b, 8c are arranged around the winding wire 2 such that platelets 5a, 5b arranged adjacent to each other are not mutually overlapping.

FIG. 2 shows schematically the application of the electrically insulating varnish 3 on the winding wire 2. The winding wire 2 is guided through a reservoir 6, in which reservoir 6 the varnish resin 4 is kept. In the varnish resin 4 the platelets 5 of the nano filler are homogenously dispersed. By conveying the winding wire 2 through the reservoir 6 the winding wire 2 is coated with the varnish resin 4 comprising the platelets 5. The conveyance of the winding wire 2 through a coating nozzle 7 occurs such that the flow and shearing forces developing here result in an alignment of the platelets 5 along the winding wire 2 such that the platelets 5 are arranged around the winding 2 like bricks. This way, the jacket is yielded, completely covering the winding wire 2, formed by platelet coats 8a, 8b, 8c. FIG. 2 fails to show that the winding wire 2, prior to the formation of the electrically insulating varnish 3 upon the winding wire 2, is cleaned and is heated after the application of the varnish resin 4 with the platelets 5 contained therein.

1.-10. (canceled)

11. An enameled wire, particularly enameled copper wire or enameled aluminum wire, with a surface of the winding wire (2) forming the core of the enameled wire (1) being completely and/or substantially completely coated with an electrically insulating varnish (3) comprising at least one varnish resin (4), with the electrically insulating varnish (3) comprising at least one nano filler, with the nano filler being formed by a plurality of platelets (5), and a platelet coat (8a, 8b, 8c) formed by the nano filler completely and/or essentially completely surrounding the winding wire (2).

12. The enameled wire of claim 11, with the platelets (5) preferably being arranged without overlapping and/or substantially without overlapping along a longitudinal axis of the winding wire (2) in the platelet coat (8a, 8b, 8c) and/or with the platelets (5) preferably being arranged without overlapping and/or substantially without overlapping in the platelet coat (8a, 8b, 8c) covering the winding wire.

13. The enameled wire of claim 11, with an aspect ratio of the nano filler and/or the platelets (5) being greater than 100.

14. The enameled wire of claim 11, with the platelets (5) showing a thickness of maximally 20 nm.

15. The enameled wire of claim 11, with the platelets (5) showing a lateral extension of minimally 100 nm.

16. The enameled wire of claim 11, with the nano filler being a phyllosilicate.

17. The enameled wire of claim 11, with the electrically insulating varnish (3) comprising up to 10% by volume nano filler.

18. The enameled wire of claim 11, with the ratio of the diameter of the winding wire to the thickness of the electrically insulating varnish (3) squared being greater or equivalent to 1 μm⁻¹.

19. The enameled wire of claim 11, with the electrically insulating varnish (3) being formed by at least two, preferably identical and/or substantially identical electrically insulating varnishes.

20. A method for the production of an enameled wire, particularly the enameled wire of claim 11, with a nano filler comprising a plurality of platelets (5) being dispersed in a varnish resin (4) and/or precursor of a varnish resin, with a winding wire (2) comprising a coating of the varnish resin (4) with the nano filler dispersed therein and/or the precursor of the varnish resin with the nano filler dispersed therein, with the winding wire (2) coated with said layer being guided through a coating nozzle (7) such that the platelets (5) of the nano filler form a platelet coat covering the winding wire (5), with the coating on the winding wire (2) being cured to form an electrically insulating varnish (3), preferably by way of heating.
